(19) United States
(12) Patent Application Publication
(10) Pub. No.: US 2017/0083665 A1
(43) Pub. Date: Mar. 23, 2017

(54) Method and System for Radiology Structured Report Creation Based on Patient-Specific Image-Derived Information

(71) Applicant: Siemens Healthcare GmbH, Erlangen (DE)

(72) Inventors: Charles Henri Florin, Long Island City, NY (US); David Liu, Franklin Park, NJ (US)

(21) Appl. No.: 15/270,964

(22) Filed: Sep. 20, 2016

Related U.S. Application Data
(60) Provisional application No. 62/222,512, filed on Sep. 23, 2015.

(51) Int. Cl. G06F 19/00

(52) U.S. Cl. CPC G06F 19/321

(57) ABSTRACT

A method and apparatus for automatic generation of a patient-specific structured report template for a radiology scan of a patient is disclosed. Anatomical structures are detected in medical image data acquired in a radiology scan of a patient. The detected anatomical structures are linked to related structured report items in a database of structured report items. A patient-specific structured report template for the radiology scan of the patient is automatically generated using the related structured report items linked to the detected anatomical structures.

This application claims the benefit of U.S. Provisional Application No. 62/222,512, filed Sep. 23, 2015, the disclosure of which is herein incorporated by reference.

### BACKGROUND OF THE INVENTION

The present invention relates to creation of radiology structured reports, and more particularly, to automatic generation of patient-specific structured report templates based on information extracted from medical images of patients.

Radiology generally refers to the use of medical imaging to diagnose and treat diseases and/or injuries within the body of a patient. Radiology encompasses various medial imaging modalities, such as X-ray, ultrasound, computed tomography (CT), magnetic resonance imaging (MRI), and positron emission tomography (PET). Once medical images of a patient are acquired, a radiologist typically interprets or “reads” the medical images and produces a radiology report, which includes the findings and impressions of the radiologist and/or a diagnosis of the patient. The radiology report is typically stored electronically along with the medical images in a picture archiving and communication system (PACS), for example using the Digital Imaging and Communications in Medicine (DICOM) format.

When reading medical images, radiologists typically create a “free-form” report by speaking their impressions and findings into a dictation device, which converts the radiologists spoken impressions and findings into a free-text document. Recently, there has been a push, for example by the Radiological Society of North America (RSNA), for radiologists to move to “structured reports” which standardize the organization, information included, and language used in radiology reports. However, structured reports and template reports have not been widely adopted despite strong evidence that they positively impact the quality of care and communications between radiology departments and referring physicians. With few notable exceptions (e.g., Mammography), Healthcare executives have been largely unsuccessful in addressing radiologists' criticism of structured reports. Besides pure and simple resistance to change, the main criticism presented by detractors of structured reports is the lack of flexibility. More specifically, when presented as templates requiring user selections with mouse clicks from a standardized nomenclature, structured reports have been known to distract radiologists from image interpretation. In particular, when starting from a templated report instead of a free-form report, radiologists need to first tailor the template to the image currently being interpreted, which typically cannot be done through the usual dictation system. However, both proponents and detractors of structured reports agree that structured reports would be advantageous for effective and efficient communication with referring physicians.

Radiology structured reports are typically filled out from a template. Examples of some such templates are available on the website: http://www.radreport.org, which includes a library of templates for different types of radiology scans. However, the medical images that are actually acquired by the scanner may have a different field of view in each case, and the organs that are actually included in the medical images may differ from case to case. Thus, a template used for the structured report for a given type of scan may list fields related to organs not included in the scan or may not list fields related to organs included in the scan. This may lead to inconvenience in filling the template report for the radiologist who is interpreting the scan. A method and system that generates a templated report that includes exactly the organs present in the scanned image is therefore desirable.

### BRIEF SUMMARY OF THE INVENTION

The present invention provides method and system for creating radiology structured reports based on patient-specific information extracted from medical images. Embodiments of the present invention address the limitations of structured reports while preserving the advantageous of structured reports. Embodiments of the present invention automatically generate patient-specific radiology structured report templates based on anatomical structures detected in medical images to generate patient-specific structured report templates that include exactly the organs that are present in the medical images.

In one embodiment of the present invention, anatomical structures are detected in medical image data acquired in a radiology scan of a patient. The detected anatomical structures are linked to related structured report items in a database of structured report items. A patient-specific structured report template for the radiology scan of the patient is automatically generated using the related structured report items linked to the detected anatomical structures.

These and other advantages of the invention will be apparent to those of ordinary skill in the art by reference to the following detailed description and the accompanying drawings.

### BRIEF DESCRIPTION OF THE DRAWINGS

FIG. 1 illustrates an exemplary template report for a chest CT scan;

FIG. 2 illustrates a method for automatically generating a patient-specific radiology structured report template according to an embodiment of the present invention;

FIG. 3 illustrates a method for creating a radiology structured report using a patient-specific radiology structured report template according to an embodiment of the present invention;

FIG. 4 illustrates a method of automatically reviewing a free-form report of a radiology scan using a patient-specific structured report template according to an embodiment of the present invention;

FIG. 5 illustrates a method of for automatically generating healthcare analytics using patient-specific structured report templates for radiology scans; and

FIG. 6 is a high-level block diagram of a computer capable of implementing the present invention.

### DETAILED DESCRIPTION

The present invention relates to methods and systems or creating radiology structured reports based on patient-specific information extracted from medical images. Embodiments of the present invention are described herein to give a visual understanding of the methods for creating radiology structured reports. A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system. Accordingly, is to be understood that embodiments of the present invention may be performed within a computer system using data stored within the computer system.

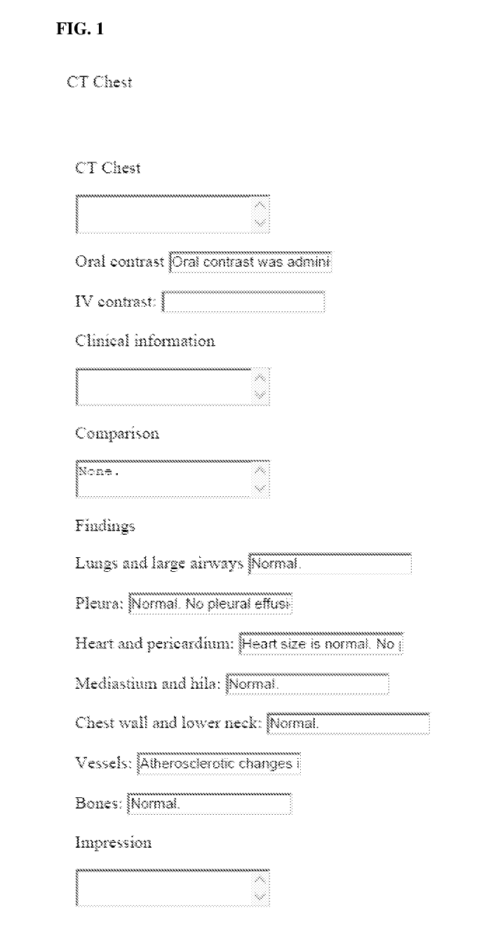

Radiology structured reports are typically filled out from a template. Examples of some such templates are available on the website: http://www.radreport.org, which includes a library of templates for different types of radiology scans. FIG. 1 illustrates an exemplary template report for a chest CT scan downloaded from http://www.radreport.org. However, the medical images that are actually acquired by the scanner in a given scan may have a different field of in different scans, and the organs that are actually included in the medical images may differ from scan to scan. Thus, a template used for the structured report for a given type of scan may list fields related to organs not included in the scan or may not list fields related to organs included in the scan. If an organ is listed in the template but not included in the scan (outside the filed of view), the radiologist/clinician may need to manually specify that the origin is outside the scan range. On the other hand, if an organ is included in the scanned image but is not listed in the template, the radiologist/clinician may have incidental findings in the scanned image but has no place to document the findings in the existing template. In yet another scenario, a radiology report created using a template report in which the organs listed do not exactly match the organs actually present in the scanned images may lead to confusion in the impressions or findings described in the report. For example, if the radiology report is described as “unremarkable” by the radiologist, then it may not be clear which organ(s) the radiologist is referring to.

Embodiments of the present invention generate a patient-specific radiology structured report template that lists exactly the organs actually present in medical images acquired in a patient scan. Embodiments of the present invention automatically parse a medical image of a patient and automatically generate the patient-specific radiology structured report template based on the parsing of the medical image.

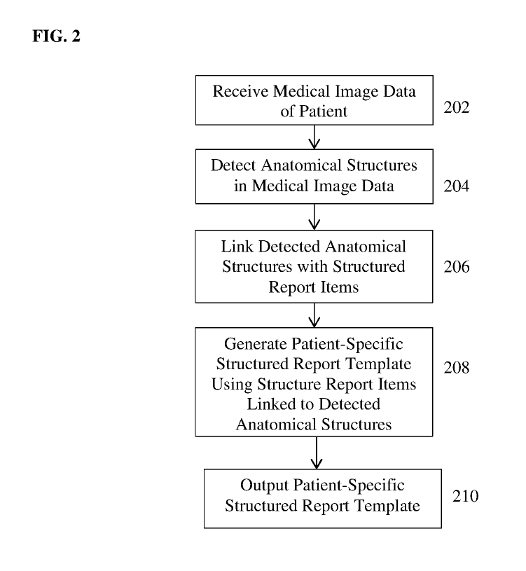

FIG. 2 illustrates a method for automatically generating a patient-specific radiology structured report template according to an embodiment of the present invention. At step 202, medical image data of a patient acquired in a radiology scan is received. The medical image data can include one or more medical images acquired in a scan of the patient using any type of imaging modality. For example, the medical image data of the patient can be acquired using X-ray, ultrasound, computed tomography (CT), magnetic resonance imaging (MRI), position emission tomography (PET), or any other type of medical imaging modality. The medical image data can be one or more 2D or 3D medical images. The medical image data may be acquired in a whole body radiology scan of the patient or may be acquired in a scan of only a portion of the patient's body. The medical image data of the patient can be received directly from an image acquisition device (scanner), such as a CT scanner, MRI scanner, etc., used to perform the radiology scan. Alternatively, the medical image data of the patient can be received by loading medical image data previously stored on a memory or storage of a computer system or receiving the medical image data via a network transmission from another computer system.

At step 204, anatomical structures are detected in the medical image data of the patient. In particular, anatomical structures such as anatomical landmarks, organs, bones, blood vessels, etc., are detected in the medical image data of the patient. The anatomical structures can be automatically detected in the medical image data by applying one or multiple computer-based automated detection algorithms to the medical image data. For example, one or more algorithms that parse the medical image data and detect multiple anatomical structures (e.g., landmarks, organs, etc.) can be applied to medical image data. Additionally, algorithms that detect and/or segment individual anatomical structures can also be applied to the medical image data. Examples of such intelligent algorithms that can be applied to the medical image data to automatically detect anatomical structures include: U.S. Publication No. 2010/0080434, entitled “Method and System for Hierarchical Parsing and Semantic Navigation of Full Body Computed Tomography Data”; U.S. Pat. No. 8,761,480, entitled “Method and System for Vascular Landmark Detection”; U.S. Pat. No. 8,837,771, entitled “Method and System for Joint Multi-Organ Segmentation in Medical Image Data using Local and Global Context”; U.S. Pat. No. 8,737,225, entitled “Method and System for Learning Based Object Detection in Medical Images”; U.S. Pat. No. 8,879,810, entitled “Method and System for Automatic Lung Segmentation in Magnetic Resonance Imaging Videos”; and U.S. Pat. No. 8,989,471, entitled “Method and System for Automatic Rib Centerline Extraction Using Learning Based Deformable Template Matching”; the disclosures of all of which are incorporated herein by reference in their entirety. It is to be understood that the present invention is not limited to the above list of intelligent computer-based algorithms for detecting anatomical structures, and other algorithms for automatically detecting one or more anatomical structures can be used as well.

In addition to detecting anatomical structures, the algorithms applied in step 204 can also extract patient-specific measurements from the detected anatomical structures. For example, physiological measurements of anatomical structures, such as sizes of various organs, organ parts, or other anatomical objects, and measurements of movement of various organs or organ parts, can be automatically calculated from the medical image data. Hemodynamic measurements related to blood flow may also be automatically calculated from the medical image data. Other types of measurements or characteristics of the anatomical structures may be automatically determined as well.

At step 206, the detected anatomical structures are linked with related structured report items. After the anatomical structures are detected in the medical image data of the patient, the detected anatomical structures are linked with related anatomical structure terminology that is meaningful in a radiology report and specific structured report items corresponding to the related anatomical structure terminology. The structured report items are items that are used to construct a structured report template. A database of such structured report items is stored. In an advantageous implementation, the structured report items included in the database can include a plurality of anatomical object fields that correspond to particular anatomical objects, such as organs, specific regions or points of interest of organs, specific bones, vessels, etc. Each of the anatomical object fields can be associated with a specific type of fillable field, such as a text box (in which a radiologist can enter text), a selection box (from which a radiologist can choose from predetermined entries), a checkbox, etc. It is possible that more than one field may be associated with a particular anatomical object. The database of structured report items can be organized hierarchically, for example by region of the body and by specific organs, and the database may include different anatomical object fields for different types of radiology scans. The structured report items are “structured” in that the items are individual items (fields) that appear in standardized templates and use standardized language.

Once the anatomical structures are detected in the medical image data, the detected anatomical structures are linked with related structured report items in the database. It is possible that a detected anatomical structure from the medical image data can be linked to a corresponding anatomical object field in the database. It is also possible that combinations of the detected anatomical structures can be linked with one or more anatomical object fields in the database. In a possible implementation, multiple detected anatomical landmarks can be used to establish a link to a field associated with a specific organ, as well as possible fields associated with sub-structures of that organ. For example, it anatomical landmarks of the “liver top” and “liver bottom” are both detected as present in a CT scan, one or several items or fields corresponding to the liver, such as a “left liver lobe” field and a “caudate lobe” field, can be identified in the database of structured report items. In an advantageous embodiment, an ontology tree can be used to link the detected anatomical structures with the related structured report items in the database. In particular, the ontology tree can be used to automatically associate the detected anatomical structures with related anatomical structure terminology used to characterize the structured report items in the database, and then the structured report items associated with the related anatomical structure terminology are identified in the database. This results in identification of a set of structured report items in the database that are linked to anatomical structures detected in the medical image data.

At step 208, a patient-specific structured report template is generated for the radiology scan of the patient using the structured report items linked to the detected anatomical structures. The patient-specific structured report template will be pre-filled with names of anatomical structures (such as liver, lung, etc.) that are verified to be present in the medical image data the patient acquired in the radiological scan, and the patient-specific structured report template will not contain anatomical structures that are not present in the medical image data of the patient. In addition to the listing of the anatomical structures that are present, the patient-specific structured report template can include one or more fillable fields associated with each such anatomical structure, to allow the user (radiologist) to enter the requested information related to each structure. The patient-specific structured report template is a “template” in that it provides a listing of organs and/or other anatomical structures for which information should be reported when a radiologist interprets the scan, and may also provide corresponding fields in which the radiologist may enter the information. The patient-specific structured report template is “patient-specific” in that the items (i.e., the listed anatomical structures and corresponding fields) included in the template are selected specifically for a particular radiology scan of the patient based on the specific anatomical structures detected in the medical images of the patient acquired in that scan. This is in contrast to conventional templates, which pre-specify anatomical structures included in a template for a particular type of scan, regardless of which anatomical structures are actually present in the acquired medical images. The patient-specific structured report template is “structured” in that even though which items (i.e., the listed anatomical structures and corresponding fields) included in the template may vary from patient to patient and scan to scan, the items that are included use standardized language and request standardized information for the listed anatomical structures.

In addition to the listed structures and corresponding fields identified in the database of structured report items, institution-specific or specialty guidelines may also be automatically included in the patient-specific structured report template. For example, if departmental guidelines in a particular department of an institution recommend that radiologists report on the general appearance of the hepatic tissue, a specific item related to the general appearance of the hepatic tissue can be added for all scans in which the hepatic tissue is present. Such an item may be added as a pre-filled sentence, where the radiologist can fill in the description of the general appearance of the hepatic tissue or select from a set of standardized descriptions of the general appearance of the hepatic tissue.

In a possible implementation, in addition to automatically generating the patient-specific structured report template, some fields of the patient-specific structured report template may be automatically filled. For example, in cases in which fields of the template require measurements related to certain anatomical structures (e.g., physiological measurements of an organ or organ part, or hemodynamic measurements of blood flow in an organ or vessel), such measurements may be automatically calculated from the medical image data during the automated detection step (step 204). The values of these measurements can then be automatically populated into the corresponding fields of the patient-specific structured report template. In addition, items related to the scan itself, such as the type of scan and parameters of the image acquisition system, can also be automatically filled in the patient-specific structured report template. Any objective information that can be automatically extracted from the medical image data can be automatically filled, but subjective items that require the judgement of the radiologist are left empty to be filled by the radiologist.

At step 210, the patient-specific structured report template is output. For example, the patient-specific structured report template may be output by displaying the patient-specific structured report template on a display device of a computer system. The patient-specific structured report template may be displayed as a fillable form in which a user (e.g., radiologist) can fill the fields of the patient-specific structured report template in order to create a structured report for the radiology scan. The patient-specific structured report template can also be output by storing the patient-specific structured report template on a memory or storage of a computer system, or transmitting the patient-specific structured report template to a remote computer system.

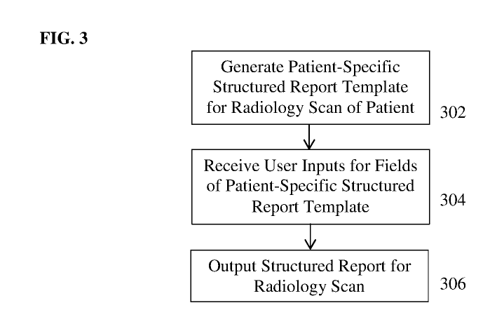

FIG. 3 illustrates a method for creating a radiology structured report using a patient-specific radiology structured report template according to an embodiment of the present invention. In this embodiment, patient-specific structured report template generated for a radiology scan of a patient is used by a user to create a structured report for the radiology scan. At step 302, a patient-specific structured report template is generated for a radiology scan of the patient. In particular, the patient-specific structured report template is generated for the radiology scan of the patient using the method of FIG. 2, described above. At step 304, user input is received for fields of the patient-specific structured report template. The patient-specific structured report template can be displayed, for example as a fillable form, on a displayed device of a computer system. In a possible embodiment, some fields of the patient-specific structured report template may be filled automatically. The user (e.g., a radiologist) then interprets or “reads” the medical image data acquired in the radiology scan of the patient and enters his or her impressions and findings as specified in the fields of the patient-specific structured report template, thus creating a structured report for the radiology scan. At step 306, the structured report of the radiology scan is output. The structured report is stored on a computer or memory of a computer system. For example, the structured report for the radiology scan may be stored with the medical image acquired in the radiology scan in a memory or storage of a computer system. The structured report may also be transmitted (e.g., via email) to a remote computer system, and/or a physical copy of the structured report may be printed. The structured report may also be displayed, for example on a display device of a computer system.

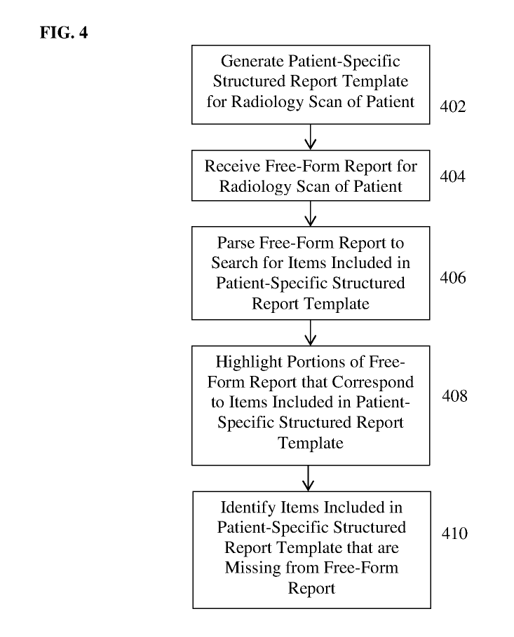

FIG. 4 illustrates a method of automatically reviewing a free-form report of a radiology scan using a patient-specific structured report template according to an embodiment of the present invention. In the embodiment of FIG. 4, a user (e.g., a radiologist creates a free-form report for a radiology scan, and the free-form report is automatically parsed using a patient-specific structured report template generated for the radiology scan. For example, this method can be applied to automatically highlight or comment on aspects of the report that are recommends by departmental guidelines and missing from the report. At step 402, a patient-specific structured report template is generated for a radiology scan of the patient. In particular, the patient-specific structured report template is generated for the radiology scan of the patient using the method of FIG. 2, described above. At step 404, a free-form report for the radiology scan of the patient is received. In this embodiment, a user (e.g., radiologist) interprets or “reads” the medical image data acquired in the scan and creates a free-form report. For example, the radiologist can speak his or her impressions and findings into a dictation device, which converts the speech into text, resulting in the free-form report.

At step 406, the free-form report is parsed to search for items included in the patient-specific structured report template. The free-form report can be parsed using a text-based search algorithm to search for portions of the free-form report that correspond to items included in the patient-specific structured report template. In a possible implementation, the free-form report may be parsed to search for portions of the free-form report that correspond to all of the items included in the patient-specific structured report template. In another possible implementation, the free-form report may be parsed to search for portions of the free-form report that correspond to one or more specified items (e.g., items corresponding to departmental guidelines) in the patient-specific structured report template. At step 408, portions of the free-form report that correspond to the items included in the patient-specific structured report template are highlighted. At step 410, items that are included in the patient-specific structured report template but missing from the free-form report are identified. The highlighted free-form report and/or a comment on or listing of the missing items in the free-form report can be output, for example by being displayed on a display device of a computer system and/or being stored in a memory or storage of a computer system. In an advantageous implementation, an alert or reminder may be sent (e.g., via email) to the radiologist who prepared the free-form report to alert the radiologist to the identified missing items.

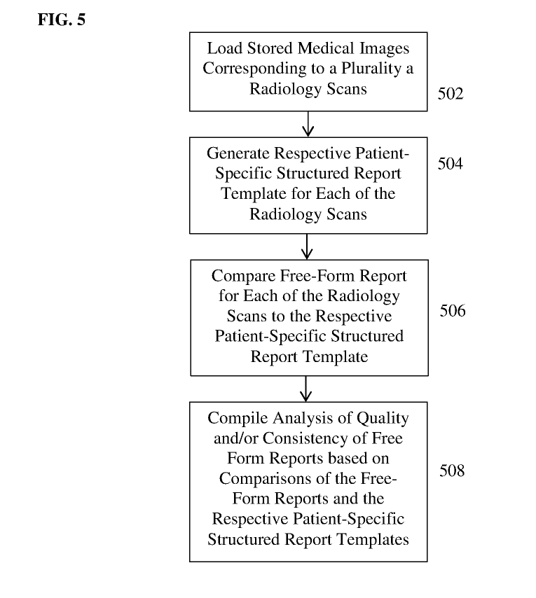

FIG. 5 illustrates a method of for automatically generating healthcare analytics using patient-specific structured report templates for radiology scans. The method of FIG. 5 can be used to parse a set of reports already filed and corresponding images to compile an analysis for healthcare executives regarding the quality and consistency of the reports prepared by departments under their responsibility over time. The analysis can then be used for business intelligence, process improvement, and/or evidence for quality-based financial incentives.

At step 502, stored medical images corresponding to a plurality of radiology scans are loaded. For example, the plurality of radiology scans may be scans by a specific department or a specific institution, or scans of a specific type, over a specified time period. At step 504, a respective patient-specific structured report template is generated for each of the plurality of radiology scans. In particular, the respective patient-specific structured report template is generated for each of the radiology scans using the method of FIG. 2, described above. At step 506, a free-form report associated with each of the plurality of radiology scans is compared with the respective patient-specific structured report template. The comparison can be performed by parsing each free-form report using a text-based search algorithm to search for portions of the free-form report that correspond to items included in the respective patient-specific structured report template. In a possible implementation, each free-form report may be parsed to search for portions of the free-form report that correspond to all of the items included in the respective patient-specific structured report template. In another possible implementation, each free-form report may be parsed to search for portions of the free-form report that correspond to one or more specified items (e.g., items corresponding to departmental guidelines) in the respective patient-specific structured report template. At step 506, an analysis of quality and/or consistency of the free form reports is compiled based on the comparisons of the free-form Reports and the respective patient-specific structured report templates. The analysis can be performed by compiling statistics related to the missing items identified in the free-form reports. For example, statics such as total number of items missing items, average number of missing items per scan, and statistics related to specific items, such as percentage of scans for which a given item is missing when it is included in the respective patient-specific structured report template. It is to be understood that other statistical measures of quality and/or consistency can be calculated as well.

As described above, in the method of FIG. 2, a patient-specific structured report template is generated for a radiology scan of a patient. In an alternative embodiment, the method described above in FIG. 2 can be similarly applied using medical images from multiple radiology scans of a patient. For example, if medical images for a previous radiology scan of a patient are stored and a new radiology scan of the patient is performed, the method can detect the anatomical structures from the medical image information from both scans to generate a patient-specific structured report template that will result in a structured report that combines the information from both scans. According to various other embodiments, the method can also base the generation of the patient-specific structured report template on other sources, such as previous radiological images and reports, lab reports, and or input by the referring physician, in addition to the current radiology scan of the patient.

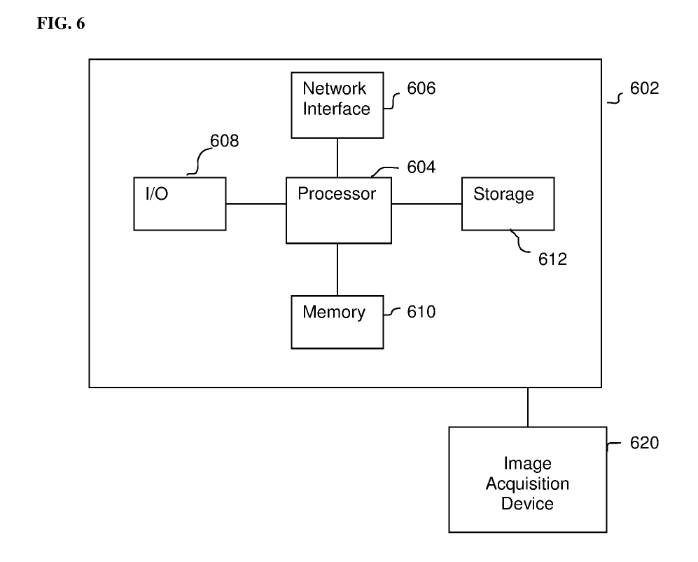

The above-described methods for generating a patient-specific structured report template, creating a radiology structured report, automatically reviewing a free-form radiology report, and automatically generating healthcare analytics using patient-specific structured report templates for radiology scans may be implemented on a computer using well-known computer processors, memory units, storage devices, computer software, and other components. A high-level block diagram of such a computer is illustrated in FIG. 6. Computer 602 contains a processor 604, which controls the overall operation of the computer 602 by executing computer program instructions which define such operation. The computer program instructions may be stored in a storage device 612 (e.g., magnetic disk) and loaded into memory 610 when execution of the computer program instructions is desired. Thus, the steps of the methods of FIGS. 2, 3, 4, and 5 may be defined by the computer program instructions stored in the memory 610 and/or storage 612 and controlled by the processor 604 executing the computer program instructions. An image acquisition device 620, such as a CT scanning device, MRI scanning device, x-ray device, ultrasound device, etc., can be connected to the computer 602 to input image data to the computer 602. It is possible to implement the image acquisition device 620 and the computer 602 as one device. It is also possible that the image acquisition device 620 and the computer 602 communicate wirelessly through a network. In a possible embodiment, the computer 602 can be located remotely with respect to the image acquisition device 620 and the method steps described herein can be performed as part of a server or cloud based service. The computer 602 also includes one or more network interfaces 606 for communicating with other devices via a network. The computer 602 also includes other input/output devices 608 that enable user interaction with the computer 602 (e.g., display, keyboard, mouse, speakers, buttons, etc.). Such input/output devices 608 may be used in conjunction with a set of computer programs for a user to “read” medical image data received from the image acquisition device 620 and enter radiology report information. One skilled in the art will recognize that an implementation of an actual computer could contain other components as well, and that FIG. 6 is a high level representation of some of the components of such a computer for illustrative purposes.

The above-described methods may be implemented using computers operating in a client-server relationship. Typically, in such a system, the client computers are located remotely from the server computer and interact via a network. The client-server relationship may be defined and controlled by computer programs running on the respective client and server computers.

The above-described methods may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIGS. 2, 3, 4, and 5. Certain steps of the methods described herein, including one or more of the steps of FIGS. 2, 3, 4, and 5, may be performed by a server or by another processor in a network-based cloud-computing system. Certain steps of the methods described herein, including one or more of the steps of FIGS. 2, 3, 4, and 5, may be performed by a client computer in a network-based cloud computing system. The steps of the methods described herein, including one or more of the steps of FIGS. 2, 3, 4, and 5, may be performed by a server and/or by a client computer in a network-based cloud computing system, in any combination

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for automatically generating a patient-specific structured report template for a radiology scan of a patient, comprising:
detecting anatomical structures in medical image data acquired in a radiology scan of a patient;
linking the detected anatomical structures to related structured report items in a database of structured report items; and
automatically generating a patient-specific structured report template for the radiology scan of the patient using the related structured report items linked to the detected anatomical structures.

2. The method of claim 1, wherein linking the detected anatomical structures to related structured report items in a database of structured report items comprises:
associating the detected anatomical structures with related anatomical structure terminology used to characterize the structured report items in the database of structured report items; and
identifying structured report items associated with the related anatomical structure terminology in the database of structured report items.

3. The method of claim 2, wherein associating the detected anatomical structures with related anatomical structure terminology used to characterize the structured report items in the database of structured report items comprises:
associating the detected anatomical structures with related anatomical structure terminology used to characterize the structured report items in the database of structured report items using an ontology tree.

4. The method of claim 1, wherein automatically generating a patient-specific structured report template for the radiology scan of the patient using the related structured report items linked to the detected anatomical structures comprises:
automatically generating a patient-specific structured report template that lists names of anatomical structures detected as present in the medical image data acquired in the radiology scan of the patient, but does not list anatomical structures not detected as present in the medical image data acquired in the radiology scan of the patient.

5. The method of claim 4, wherein the related structured report items include fields corresponding to anatomical objects related to the detected anatomical structures, and automatically generating a patient-specific structured report template that lists names of anatomical structures detected as present in the medical image data acquired in the radiology scan of the patient, but does not list anatomical structures not detected as present in the medical image data acquired in the radiology scan of the patient comprises:
automatically generating a patient-specific structured report template that lists the names of the anatomical structures detected as present in the medical image data acquired in the radiology scan of the patient and provides one or more fields corresponding to each of the anatomical structures detected as present in the medical image data acquired in the radiology scan of the patient.

6. The method of claim 1, further comprising:
automatically determining measurements associated with the detected anatomical structures in the medical image data acquired in the radiology scan of the patient; and
automatically filling one or more fields of the patient-specific structured report template using the measurements. The method of claim 1, further comprising:
creating a structured report for the radiology scan of the patient using the patient-specific structured report template.

8. The method of claim 7, wherein creating a structured report for the radiology scan of the patient using the patient-specific structured report template comprises:
receiving user inputs to fillable fields included in the patient-specific structured report template.

9. The method of claim 1, further comprising:
receiving a free-form report for the radiology scan of the patient; and
automatically parsing the free-form report to search for portions of the free-form report corresponding one or more items included in the patient-specific structured report template generated for the radiology scan of the patient.

10. The method of claim 9, further comprising:
highlighting one or more portions of the free-form report corresponding to one or more items included in the patient-specific structured report template generated for the radiology scan of the patient.

11. The method of claim 9, further comprising:
identifying at least one item included in the patient-specific structured report template generated for the radiology scan of the patient that is missing from the free-form report.

12. The method of claim 11, further comprising:
generating an alert to alert a user of the at least one item included in the patient-specific structured report template generated for the radiology scan of the patient that is missing from the free-form report.

13. The method of claim 1, further comprising:
repeating the detecting, linking, and automatically generating steps for each of a plurality of radiology scans, resulting in a respective patient-specific structured report template for each of the plurality of radiology scans;
comparing a respective free-form report associated with each of the plurality of radiology scans with the respective patient-specific structured report template for each of the plurality of radiology scans to search each respective free-form report for one or more items included the respective patient-specific structured report template; and
compiling statistics related to items determined to be missing in the respective free-form reports based on the comparison of the respective free-form reports with the respective patient-specific structured report template.

14. An apparatus for automatically generating a patient-specific structured report template for a radiology scan of a patient, comprising:
means for detecting anatomical structures in medical image data acquired in a radiology scan of a patient;
means for linking the detected anatomical structures to related structured report items in a database of structured report items; and
means for automatically generating a patient-specific structured report template for the radiology scan of the patient using the related structured report items linked to the detected anatomical structures.

15. The apparatus of claim 14, wherein the means for linking the detected anatomical structures to related structured report items in a database of structured report items comprises:
means for associating the detected anatomical structures with related anatomical structure terminology used to characterize the structured report items in the database of structured report items; and
means for identifying structured report items associated with the related anatomical structure terminology in the database of structured report items.

16. The apparatus of claim 14, wherein the means for automatically generating a patient-specific structured report template for the radiology scan of the patient using the related structured report items linked to the detected anatomical structures comprises:
means for automatically generating a patient-specific structured report template that lists names of anatomical structures detected as present in the medical image data acquired in the radiology scan of the patient, but does not list anatomical structures not detected as present in the medical image data acquired in the radiology scan of the patient.

17. The apparatus of claim 14, further comprising:
means for creating a structured report for the radiology scan of the patient using the patient-specific structured report template.

18. The apparatus of claim 14, further comprising:
means for automatically parsing a free-form report for the radiology scan of the patient to search for portions of the free-form report corresponding one or more items included in the patient-specific structured report template generated for the radiology scan of the patient.

19. The apparatus of claim 19, further comprising:
means for identifying at least one item included in the patient-specific structured report template generated for the radiology scan of the patient that is missing from the free-form report.

20. A non-transitory computer readable medium storing computer program instructions for automatically generating a patient-specific structured report template for a radiology scan of a patient, the computer program instructions defining operations comprising:
detecting anatomical structures in medical image data acquired in a radiology scan of a patient;
linking the detected anatomical structures to related structured report items in a database of structured report items; and
automatically generating a patient-specific structured report template for the radiology scan of the patient using the related structured report items linked to the detected anatomical structures.

21. The non-transitory computer readable medium of claim 20, wherein linking the detected anatomical structures to related structured report items in a database of structured report items comprises:
associating the detected anatomical structures with related anatomical structure terminology used to characterize the structured report items in the database of structured report items; and
identifying structured report items associated with the related anatomical structure terminology in the database of structured report items.

22. The non-transitory computer readable medium of claim 20, wherein automatically generating a patient-specific structured report template for the radiology scan of the patient using the related structured report items linked to the detected anatomical structures comprises:
automatically generating a patient-specific structured report template that lists names of anatomical structures detected as present in the medical image data acquired in the radiology scan of the patient, but does not list anatomical structures not detected as present in the medical image data acquired in the radiology scan of the patient.

23. The non-transitory computer readable medium of claim 20, wherein the operations further comprise:
automatically determining measurements associated with the detected anatomical structures in the medical image data acquired in the radiology scan of the patient; and
automatically filling one or more fields of the patient-specific structured report template using the measurements.

24. The non-transitory computer readable medium of claim 20, wherein the operations further comprise:
creating a structured report for the radiology scan of the patient using the patient-specific structured report template.

25. The non-transitory computer readable medium of claim 20, wherein the operations further comprise:
receiving a free-form report for the radiology scan of the patient; and
automatically parsing the free-form report to search for portions of the free-form report corresponding one or more items included in the patient-specific structured report template generated for the radiology scan of the patient.

26. The non-transitory computer readable medium of claim 25, wherein the operations further comprise:
identifying at least one item included in the patient-specific structured report template generated for the radiology scan of the patient that is missing from the free-form report.

27. The non-transitory computer readable medium of claim 20, wherein the operations further comprise:
repeating the detecting, linking, and automatically generating steps for each of a plurality of radiology scans, resulting in a respective patient-specific structured report template for each of the plurality of radiology scans;
comparing a respective free-form report associated with each of the plurality of radiology scans with the respective patient-specific structured report template for each of the plurality of radiology scans to search each respective free-form report for one or more items included the respective patient-specific structured report template; and
compiling statistics related to items determined to be missing in the respective free-form reports based on the comparison of the respective free-form reports with the respective patient-specific structured report template.
